(19) United States
(12) Patent Application Publication
(10) Pub. No.: US 2026/0006570 A1
(43) Pub. Date: Jan. 1, 2026

(54) Electronic Devices with Secure Ultra-Wideband Ranging

(71) Applicant: Apple Inc., Cupertino, CA (US)

(72) Inventors: Hao Zhou, Sunnyvale, CA (US); Ming Lei, Sunnyvale, CA (US); Pengcheng Zhan, Sunnyvale, CA (US)

(21) Appl. No.: 18/759,230

(22) Filed: Jun. 28, 2024

(51) Int. Cl. H04W 64/00; H04B 1/7163; H04J 3/06; H04L 1/00; H04W 12/10

(52) U.S. Cl. CPC H04W 64/00; H04B 1/7163; H04J 3/0661; H04L 1/0061; H04W 12/10

(57) ABSTRACT

A communications system may include first and second electronic devices. The first device may transmit an ultra-wideband (UWB) signal to the second device. The UWB signal may include pulses that represent a ranging frame. The pulses may include a series of pulses representing a physical layer (PHY) payload of the ranging frame. The second device may estimate a range to the first device and/or a location of the first device based on a correlation of the series of pulses representing the PHY payload of the ranging frame. The first device may apply a coding scheme to the PHY payload that reduces, or minimizes, a bit error rate of the correlation at the second device, may apply a cyclic redundancy check, may transmit the PHY payload using a spreading factor greater than one, and/or may apply encryption to the PHY payload for integrity check purposes.

### FIELD

This disclosure relates generally to wireless communications by electronic devices.

### BACKGROUND

Communications systems and methods are used to convey wireless signals between nodes of a communications network. The nodes can include user equipment devices, wireless access points, wireless base stations, or other electronic devices.

A first node can perform localization operations on a second node using ultra-wideband (UWB) signals conveyed between the nodes. If care is not taken, the localization operations can consume excessive resources in one or both nodes, can exhibit insufficient accuracy, or can exhibit insufficient levels of security.

### SUMMARY

A communications system may include first and second electronic devices. The first device may transmit an ultra-wideband (UWB) signal to the second device. The UWB signal may include pulses that represent a ranging frame. The pulses may include a series of pulses representing a physical layer (PHY) payload of the ranging frame. The second device may estimate a range to the first device and/or a location of the first device based on a correlation of the series of pulses representing the PHY payload of the ranging frame. Performing ranging based on a correlation of the PHY payload may allow for the omission of a scrambled time sequence (STS) in the ranging frame if desired, increasing channel usage efficiency.

The first device may apply a coding scheme to the PHY payload that reduces (or even minimizes) a bit error rate of the correlation at the second device. The first device may apply a cyclic redundancy check to the ranging frame. The first device may transmit the PHY payload of the ranging frame using a spreading factor that matches a spreading factor of the STS, such as a spreading factor greater than one. The first device may apply encryption to the PHY payload and may generate an integrity check value included in the ranging frame. The second device may reverse the coding scheme applied to the PHY payload by the first device. The second device may validate the cyclic redundancy check and/or the integrity check value. These techniques may allow for accurate range estimation while also exhibiting sufficient levels of security and improved channel usage efficiency.

An aspect of the disclosure provides a method of operating an electronic device. The method can include receiving, from an external device, an ultra-wideband (UWB) signal that includes a ranging frame. The method can include estimating, using one or more processors, a range to the external device based on a correlation of pulses in the UWB signal that represent a physical layer (PHY) payload of the ranging frame.

An aspect of the disclosure provides a method of operating an electronic device. The method can include generating, using one or more processors, a ranging frame that includes a physical layer (PHY) payload. The method can include transmitting, using one or more antennas, an ultra-wideband (UWB) signal that includes pulses representing the ranging frame. The pulses can include a series of pulses representing the PHY payload. The series of pulses can have the spreading factor greater than one.

An aspect of the disclosure provides an electronic device. The electronic device can include one or more antennas configured to receive an ultra-wideband (UWB) signal from an external device, the UWB signal including a ranging frame. The electronic device can include one or more processors. The one or more processors can be configured to generate a channel impulse response (CIR) value based on a correlation of pulses in the UWB signal, the pulses representing a physical layer (PHY) payload of the ranging frame. The one or more processors can be configured to estimate a location of the external device based on the CIR value. The electronic device can include a display configured to display an image indicative of the estimated location.

### BRIEF DESCRIPTION OF THE DRAWINGS

FIG. 1 is a perspective view of an illustrative wireless communications system that includes electronic devices with wireless ranging and localization capabilities in accordance with some embodiments.

FIG. 2 is a schematic diagram of illustrative circuitry in an electronic device in accordance with some embodiments.

FIG. 3 is a schematic diagram of illustrative wireless circuitry in accordance with some embodiments.

FIG. 4 is an illustrative diagram showing how the location (e.g., range and angle of arrival) of an external node in a network may be determined relative to an electronic device in accordance with some embodiments.

FIG. 5 is a diagram showing how illustrative ultra-wideband antennas in an electronic device may be used for detecting angle of arrival in accordance with some embodiments.

FIG. 6 is a timing diagram of an illustrative ultra-wideband signal that may be transmitted from a first electronic device to a second electronic device for performing wireless ranging and localization in accordance with some embodiments.

FIG. 7 is a diagram of illustrative ranging frames that may be transmitted using an ultra-wideband signal in accordance with some embodiments.

FIG. 8 is a flow chart of illustrative operations involved in performing wireless ranging and localization using first and second electronic devices in accordance with some embodiments.

FIGS. 9 and 10 are diagrams showing how an illustrative ranging frame may be integrity protected in accordance with some embodiments.

FIG. 11 is a timing diagram of illustrative physical layer data payloads in a ranging frame transmitted using an ultra-wideband signal in accordance with some embodiments.

FIG. 12 is a diagram showing how an illustrative device may perform wireless ranging and localization using the physical data payload of a received ranging frame in accordance with some embodiments.

FIG. 13 is a flow chart of illustrative operations involved in performing wireless ranging and localization using the physical data payload of a received ranging frame in accordance with some embodiments.

### DETAILED DESCRIPTION

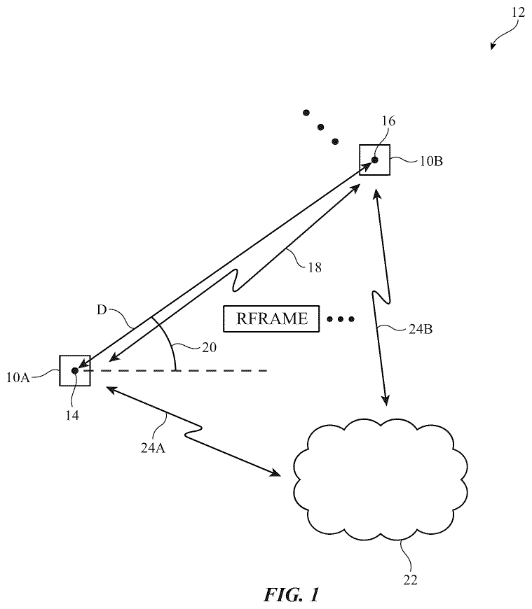

FIG. 1 is a diagram of an illustrative communications system 12. Communications system 12 (sometimes referred to herein as communications network 12, network 12, or system 12) may include network nodes that communicate with each other via wireless and/or wired links. The nodes of communications system 12 may include one or more electronic devices 10. Electronic devices 10 may include at least a first electronic device 10A and a second electronic device 10B. Devices 10A and 10B may be user equipment devices (e.g., owned and/or operated by an end user) and are sometimes also referred to herein as user equipment (UE) devices 10A and 10B.

Communications system 12 may also include network portion 22. Device 10A may use wireless signals 24A to wirelessly communicate with one or more nodes of network portion 22 (e.g., other devices 10, wireless access points, wireless base stations, communications satellites, satellite ground stations, etc.). Similarly, device 10B may use wireless signals 24B to wirelessly communicate with one or more nodes of network portion 22 (e.g., other devices 10, wireless access points, wireless base stations, communications satellites, satellite ground stations, etc.). Wireless signals 24A and 24B are conveyed using non-ultra-wideband (non-UWB) communications protocols and are sometimes referred to herein as non-UWB signals 24A and 24B.

Network portion 22 may include any desired number of network nodes, terminals, and/or end hosts that are communicably coupled together using communications paths that include wired and/or wireless links. The wired links may include cables (e.g., ethernet cables, optical fibers or other optical cables that convey signals using light, telephone cables, etc.). Network portion 22 may include one or more relay networks, mesh networks, local area networks (LANs), wireless local area networks (WLANs), ring networks (e.g., optical rings), cloud networks, virtual/logical networks, the Internet, combinations of these, satellite communications networks (e.g., one or more non-terrestrial networks including a constellation of communications satellites and satellite ground stations), and/or any other desired network nodes coupled together using any desired network topologies. The network nodes, terminals, and/or end hosts may include network switches, network routers, optical add-drop multiplexers, other multiplexers, repeaters, modems, servers, network cards, wireless access points, wireless base stations, devices 10 (e.g., UE devices), and/or any other desired network components. The network nodes in network portion 22 may include physical components such as electronic devices, servers, computers, user equipment, etc., and/or may include virtual components that are logically defined in software and that are distributed across (over) two or more underlying physical devices (e.g., in a cloud network configuration).

In addition to wirelessly communicating with network portion 22, devices 10A and 10B may also wirelessly communicate with each other using wireless signals 18. Wireless signals 18 may, for example, be conveyed directly between devices 10A and 10B without being received, re-transmitted, routed, and/or relayed by other intervening devices. Wireless signals 18 may propagate between devices 10A and 10B over a line-of-sight (LOS) path and, in practice, over additional paths (e.g., reflected signal paths). Wireless signals 18 may be received at devices 10A and 10B via the LOS path before being received via other paths.

Wireless signals 18 may include radio-frequency signals such as cellular telephone signals, wireless local area network (WLAN) signals, wireless personal area network (WPAN) signals, satellite communications signals, device-to-device (D2D) signals, cellular sideband signals, or other types of wireless signals. Implementations in which wireless signals 18 include ultra-wideband (UWB) signals are described herein as an example. Wireless signals 18 are therefore sometimes referred to herein as UWB signals 18.

UWB signals 18 may be conveyed according to a UWB communications protocol such as an IEEE 802.15.4 protocol (e.g., an IEEE 802.15.4z standard or specification). The UWB protocol supports wireless ranging and localization operations in which UWB signals 18 are used to determine the relative location or position between devices such as devices 10A and 10B. Devices 10 that support wireless ranging and localization using UWB signals 18 are sometimes also referred to as ranging capable devices (RDEVs).

Consider an example in which device 10A is at a first spatial location 14 and device 10B is at a second spatial location 16 that is separated from spatial location 14 by distance D. Device 10A and/or device 10B may use transmitted and/or received UWB signals 18 to identify, determine, and/or estimate the distance D. If desired, device 10A and/or device 10B may use measurements of distance D (e.g., as performed using two or more antennas separated by a known distance on each device) to identify the angle-of-arrival (AoA) 20 of UWB signals 18. AoA 20 may correspond to the angular position of one device relative to the other. Device 10A may, for example, use a detection of distance D and a detection of AoA 20 to know the precise spatial position of device 10B relative to device 10A (e.g., in polar coordinates, spherical coordinates, or any other desired coordinate system). Distance D is sometimes also referred to herein as the range D of device 10A relative to device 10B or the range D of device 10B relative to device 10A.

UWB signals 18 are transmitted based on an impulse radio signaling scheme and contain a series of band-limited data pulses over time. The pulses in UWB signals 18 may be used to encode and convey wireless data. Each pulse may, for example, represent a corresponding bit of the wireless data. The sign (polarity) of each pulse may, for example, be used to represent a binary value of 1 or a binary value of 0 for its corresponding bit of wireless data. The wireless data may be organized into packets or frames such as ranging frames RFRAME for use in performing wireless ranging and localization. The pulses in UWB signals 18 may represent the encoded bits of ranging frames RFRAME. A ranging frame RFRAME may have a frame (packet) structure determined by the corresponding UWB communications protocol. Devices 10A and/or 10B may analyze transmission time stamps included within ranging frames RFRAME and corresponding reception time stamps to determine the time-of-flight of ranging frames RFRAME. Devices 10A and/or 10B may determine distance D based on the time-of-flight and the known propagation speed of UWB signals 18 (e.g., the speed of light in the propagation medium of communications system 12).

UWB signals 18 may be conveyed in one or more UWB frequency bands such as a first UWB communications band at 6.5 GHZ, a second UWB communications band at 8.0 GHZ, and/or other UWB bands. UWB signals 18 may have relatively high bandwidths such as bandwidths between 499 MHz and 1331 MHz, bandwidths greater than 500 MHZ, bandwidths of around 500 MHZ, etc. The presence of lower frequencies in the baseband may sometimes allow ultra-wideband signals to penetrate through objects such as walls.

Devices 10 may be portable electronic devices or other suitable electronic devices. For example, a device 10 may be a laptop computer, a tablet computer, a somewhat smaller device such as a wrist-watch device, pendant device, headphone device, earpiece device, headset device (e.g., virtual, augmented, or mixed reality glasses or goggles), or another wearable or miniature device, a handheld device such as a cellular telephone, a media player, or other small portable device. Device 10 may also be a set-top box, a desktop computer, a display into which a computer or other processing circuitry has been integrated, a display without an integrated computer, a wireless access point, a wireless base station, an accessory device, a peripheral device, a wireless stylus, a gaming controller, an electronic device incorporated into a kiosk, building, or vehicle, or other suitable electronic equipment. As further examples, device 10 may include a key fob, a wireless tracking tag, a wallet, a book, a pen, or other object that has been provided with a low-power transmitter (e.g., an RFID transmitter or other transmitter), a thermostat, a smoke detector, a Bluetooth® Low Energy (Bluetooth LE) beacon, a server, a heating, ventilation, and air conditioning (HVAC) system (sometimes referred to as a temperature-control system), a light source such as a light-emitting diode (LED) bulb, a light switch, a power outlet, an occupancy detector (e.g., an active or passive infrared light detector, a microwave detector, etc.), a door sensor, a moisture sensor, an electronic door lock, a security camera, or other device. Device 10 may, if desired, be an electronic device that incorporates the functionality of two or more of these types of devices or other types of devices if desired.

The components of device 10 may be included within a housing of device 10. The housing, which may sometimes be referred to as a case, may be formed of plastic, glass, ceramics, fiber composites, metal (e.g., stainless steel, aluminum, etc.), other suitable materials, or a combination of these materials. In some situations, parts of the housing may be formed from dielectric or other low-conductivity material (e.g., glass, ceramic, plastic, sapphire, etc.). In other situations, the housing or at least some of the structures that make up the housing may be formed from metal elements.

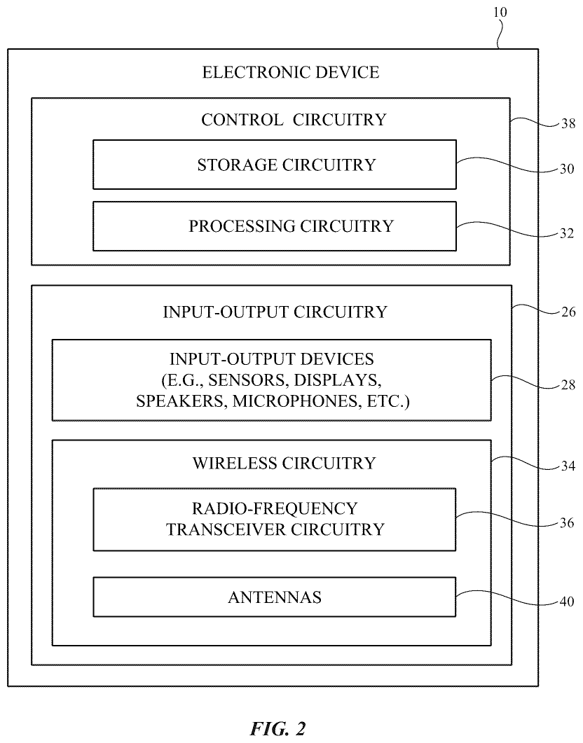

A schematic diagram of illustrative components that may be used in device 10 is shown in FIG. 2. As shown in FIG. 2, device 10 (e.g., device 10A or device 10B of FIG. 1) may include control circuitry 38. Control circuitry 38 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc.

Control circuitry 38 may include processing circuitry such as processing circuitry 32. Processing circuitry 32 may be used to control the operation of device 10. Processing circuitry 32 may include one or more processors such as microprocessors, microcontrollers, digital signal processors, host processors, baseband processor integrated circuits, application specific integrated circuits, graphics processing units, central processing units (CPUs), etc. Control circuitry 38 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 38 may be used to run software on device 10 such as internet browsing applications, voice-over-internet-protocol (VOIP) telephone call applications, email applications, media playback applications, operating system functions, etc. To support interactions with external equipment, control circuitry 38 may be used in implementing communications protocols. Communications protocols that may be implemented using control circuitry 38 include internet protocols, wireless local area network protocols (e.g., IEEE 802.11 protocols-sometimes referred to as Wi-Fi®), protocols for other short-range wireless communications links such as the Bluetooth® protocol or other WPAN protocols, IEEE 802.11ad protocols, cellular telephone protocols, MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output circuitry 26. Input-output circuitry 26 may include input-output devices 28. Input-output devices 28 may be used to allow data to be supplied to device 10 and to allow data to be provided from device 10 to external devices. Input-output devices 28 may include user interface devices, data port devices, sensors, and other input-output components. For example, input-output devices 28 may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and other sensors and input-output components. The sensors in input-output devices 28 may include front-facing sensors that gather sensor data through display 14. The front-facing sensors may be optical sensors. The optical sensors may include an image sensor (e.g., a front-facing camera), an infrared sensor, and/or an ambient light sensor. The infrared sensor may include one or more infrared emitters (e.g., a dot projector and a flood illuminator) and/or one or more infrared image sensors.

Input-output circuitry 26 may include wireless circuitry such as wireless circuitry 34 for wirelessly conveying radio-frequency signals. While control circuitry 38 is shown separately from wireless circuitry 34 in the example of FIG. 2 for the sake of clarity, wireless circuitry 34 may include processing circuitry that forms a part of processing circuitry 32 and/or storage circuitry that forms a part of storage circuitry 30 of control circuitry 38 (e.g., portions of control circuitry 38 may be implemented on wireless circuitry 34). As an example, control circuitry 38 may include baseband circuitry or other control components that form a part of wireless circuitry 34. The baseband circuitry may, for example, access a communication protocol stack on corresponding storage circuitry (e.g., storage circuitry 30) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

Wireless circuitry 34 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

Wireless circuitry 34 may include radio-frequency transceiver circuitry 36 for handling transmission and/or reception of radio-frequency signals within corresponding frequency bands at radio frequencies (sometimes referred to herein as communications bands or simply as “bands”). The frequency bands handled by radio-frequency transceiver circuitry 36 may include wireless local area network (WLAN) frequency bands (e.g., Wi-Fi® (IEEE 802.11) or other WLAN communications bands) such as a 2.4 GHz WLAN band (e.g., from 2400 to 2480 MHZ), a 5 GHZ WLAN band (e.g., from 5180 to 5825 MHZ), a Wi-Fi® 6E band (e.g., from 5925-7125 MHz), and/or other Wi-Fi® bands (e.g., from 1875-5160 MHZ), wireless personal area network (WPAN) frequency bands such as the 2.4 GHz Bluetooth® band or other WPAN communications bands, cellular telephone communications bands such as a cellular low band (LB) (e.g., 600 to 960 MHZ), a cellular low-midband (LMB) (e.g., 1400 to 1550 MHZ), a cellular midband (MB) (e.g., from 1700 to 2200 MHZ), a cellular high band (HB) (e.g., from 2300 to 2700 MHZ), a cellular ultra-high band (UHB) (e.g., from 3300 to 5000 MHz, or other cellular communications bands between about 600 MHz and about 5000 MHZ), 3G bands, 4G LTE bands, 3GPP 5G New Radio Frequency Range 1 (FR1) bands below 10 GHz, 3GPP 5G New Radio (NR) Frequency Range 2 (FR2) bands between 20 and 60 GHz, other centimeter or millimeter wave frequency bands between 10-300 GHz, near-field communications frequency bands (e.g., at 13.56 MHZ), satellite navigation frequency bands such as the Global Positioning System (GPS) L1 band (e.g., at 1575 MHz), L2 band (e.g., at 1228 MHZ), L3 band (e.g., at 1381 MHz), L4 band (e.g., at 1380 MHz), and/or L5 band (e.g., at 1176 MHZ), a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHZ and/or a second UWB communications band at 8.0 GHZ), communications bands under the family of 3GPP wireless communications standards, communications bands under the IEEE 802.XX family of standards, satellite communications bands such as an L-band, S-band (e.g., from 2-4 GHZ), C-band (e.g., from 4-8 GHZ), X-band, Ku-band (e.g., from 12-18 GHz), Ka-band (e.g., from 26-40 GHZ), etc., industrial, scientific, and medical (ISM) bands such as an ISM band between around 900 MHz and 950 MHz or other ISM bands below or above 1 GHZ, one or more unlicensed bands, one or more bands reserved for emergency and/or public services, and/or any other desired frequency bands of interest. Wireless circuitry 34 may also be used to perform spatial ranging operations if desired.

Radio-frequency transceiver circuitry 36 may include respective transceivers (e.g., transceiver integrated circuits or chips) that handle each of these frequency bands or any desired number of transceivers that handle two or more of these frequency bands. In scenarios where different transceivers are coupled to the same antenna, filter circuitry (e.g., duplexer circuitry, diplexer circuitry, low pass filter circuitry, high pass filter circuitry, band pass filter circuitry, band stop filter circuitry, etc.), switching circuitry, multiplexing circuitry, or any other desired circuitry may be used to isolate radio-frequency signals conveyed by each transceiver over the same antenna (e.g., filtering circuitry or multiplexing circuitry may be interposed on a radio-frequency transmission line shared by the transceivers). Radio-frequency transceiver circuitry 36 may include one or more integrated circuits (chips), integrated circuit packages (e.g., multiple integrated circuits mounted on a common printed circuit in a system-in-package device, one or more integrated circuits mounted on different substrates, etc.), power amplifier circuitry, up-conversion circuitry, down-conversion circuitry, low-noise input amplifiers, passive radio-frequency components, switching circuitry, transmission line structures, and other circuitry for handling radio-frequency signals and/or for converting signals between radio-frequencies, intermediate frequencies, and/or baseband frequencies.

In general, radio-frequency transceiver circuitry 36 may cover (handle) any desired frequency bands of interest. As shown in FIG. 2, wireless circuitry 34 may include antennas 40. Radio-frequency transceiver circuitry 36 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to freespace through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from stacked patch antenna structures, loop antenna structures, patch antenna structures, inverted-F antenna structures, slot antenna structures, planar inverted-F antenna structures, waveguide structures, monopole antenna structures, dipole antenna structures, helical antenna structures, Yagi (Yagi-Uda) antenna structures, hybrids of these designs, etc. If desired, antennas 40 may include antennas with dielectric resonating elements such as dielectric resonator antennas. If desired, one or more of antennas 40 may be cavity-backed antennas. Two or more antennas 40 may be arranged in a phased antenna array if desired (e.g., for conveying centimeter and/or millimeter wave signals within a signal beam formed in a desired beam pointing direction that may be steered/adjusted over time). Different types of antennas may be used for different bands and combinations of bands.

In some implementations that are described herein as an example, antennas 40 include a set of one or more antennas that convey UWB signals 18 (FIG. 1). Antennas 40 that convey UWB signals 18 may only convey UWB signals (e.g., may be dedicated UWB antennas) or may convey both UWB signals 18 and non-UWB signals (e.g., wireless signals 24A or 24B of FIG. 1). The antennas 40 that convey UWB signals may, if desired, include a triplet or doublet of antennas that are in a known spatial (phased) relationship with respect to each other on device 10.

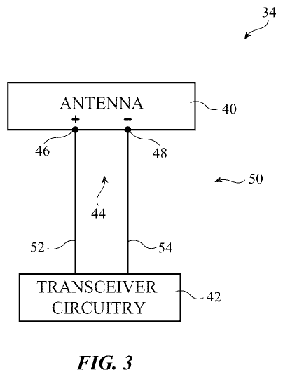

A schematic diagram of wireless circuitry 34 is shown in FIG. 3. As shown in FIG. 3, wireless circuitry 34 may include transceiver circuitry 36 that is coupled to a given antenna 40 using a radio-frequency transmission line path such as radio-frequency transmission line path 50.

To provide antenna structures such as antenna 40 with the ability to cover different frequencies of interest, antenna 40 may be provided with circuitry such as filter circuitry (e.g., one or more passive filters and/or one or more tunable filter circuits). Discrete components such as capacitors, inductors, and resistors may be incorporated into the filter circuitry. Capacitive structures, inductive structures, and resistive structures may also be formed from patterned metal structures (e.g., part of an antenna). If desired, antenna 40 may be provided with adjustable circuits such as tunable components that tune the antenna over communications (frequency) bands of interest. The tunable components may be part of a tunable filter or tunable impedance matching network, may be part of an antenna resonating element, may span a gap between an antenna resonating element and antenna ground, etc.

Radio-frequency transmission line path 50 may include one or more radio-frequency transmission lines (sometimes referred to herein simply as transmission lines). Radio-frequency transmission line path 50 (e.g., the transmission lines in radio-frequency transmission line path 50) may include a positive signal conductor such as positive signal conductor 52 and a ground signal conductor such as ground conductor 54.

The transmission lines in radio-frequency transmission line path 50 may, for example, include coaxial cable transmission lines (e.g., ground conductor 54 may be implemented as a grounded conductive braid surrounding signal conductor 52 along its length), stripline transmission lines (e.g., where ground conductor 54 extends along two sides of signal conductor 52), a microstrip transmission line (e.g., where ground conductor 54 extends along one side of signal conductor 52), coaxial probes realized by a metalized via, edge-coupled microstrip transmission lines, edge-coupled stripline transmission lines, waveguide structures (e.g., coplanar waveguides or grounded coplanar waveguides), combinations of these types of transmission lines and/or other transmission line structures, etc. In one suitable arrangement that is sometimes described herein as an example, radio-frequency transmission line path 50 may include a stripline transmission line coupled to transceiver circuitry 36 and a microstrip transmission line coupled between the stripline transmission line and antenna 40.

Transmission lines in radio-frequency transmission line path 50 may be integrated into rigid and/or flexible printed circuit boards. In one suitable arrangement, radio-frequency transmission line path 50 may include transmission line conductors (e.g., signal conductors 52 and ground conductors 54) integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

A matching network may include components such as inductors, resistors, and capacitors used in matching the impedance of antenna 40 to the impedance of radio-frequency transmission line path 50. Matching network components may be provided as discrete components (e.g., surface mount technology components) or may be formed from housing structures, printed circuit board structures, traces on plastic supports, etc. Components such as these may also be used in forming filter circuitry in antenna(s) 40 and may be tunable and/or fixed components.

Radio-frequency transmission line path 50 may be coupled to antenna feed structures associated with antenna 40. As an example, antenna 40 may form an inverted-F antenna, a planar inverted-F antenna, a patch antenna, or other antenna having an antenna feed 44 with a positive antenna feed terminal such as positive antenna feed terminal 46 and a ground antenna feed terminal such as ground antenna feed terminal 48. Positive antenna feed terminal 46 may be coupled to an antenna resonating element for antenna 40. Ground antenna feed terminal 48 may be coupled to an antenna ground for antenna 40.

Signal conductor 52 may be coupled to positive antenna feed terminal 46 and ground conductor 54 may be coupled to ground antenna feed terminal 48. Other types of antenna feed arrangements may be used if desired. For example, antenna 40 may be fed using multiple feeds each coupled to a respective port of transceiver circuitry 36 over a corresponding transmission line. If desired, signal conductor 52 may be coupled to multiple locations on antenna 40 (e.g., antenna 40 may include multiple positive antenna feed terminals coupled to signal conductor 52 of the same radio-frequency transmission line path 50). Switches may be interposed on the signal conductor between transceiver circuitry 36 and the positive antenna feed terminals if desired (e.g., to selectively activate one or more positive antenna feed terminals at any given time). The illustrative feeding configuration of FIG. 3 is merely an example implementation and other configurations may be used.

During operation, device 10 may communicate with external wireless equipment. If desired, device 10 may conveyed UWB signals 18 with an external device to perform wireless ranging and localization on the external device (e.g., to identify a location/position of the external device relative to device 10). Device 10 may identify the relative location of the external device by identifying a range to the external device (e.g., distance D of FIG. 1) and the AoA of UWB signals 18 over the LOS path between device 10 and the external device (e.g., AoA 20 of FIG. 2).

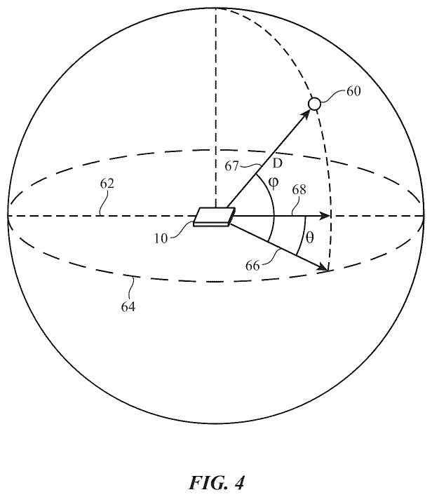

FIG. 4 illustrates how the position and orientation of device 10 relative to nearby nodes such as node 60 may be determined. In the example of FIG. 4, the control circuitry on device 10 (e.g., control circuitry 38 of FIG. 2) uses a horizontal polar coordinate system to determine the location and orientation of device 10 relative to node 60 (e.g., an external device such as device 10B of FIG. 1 in examples where device 10 of FIG. 4 forms device 10A of FIG. 1). In this type of coordinate system, the control circuitry may determine an azimuth angle θ and/or an elevation angle φ to describe the position of nearby nodes 60 relative to device 10. The control circuitry may define a reference plane such as local horizon 64 and a reference vector such as reference vector 68. Local horizon 64 may be a plane that intersects device 10 and that is defined relative to a surface of device 10 (e.g., the front or rear face of device 10). Reference vector 68 (sometimes referred to as the “north” direction) may be a vector in local horizon 64.

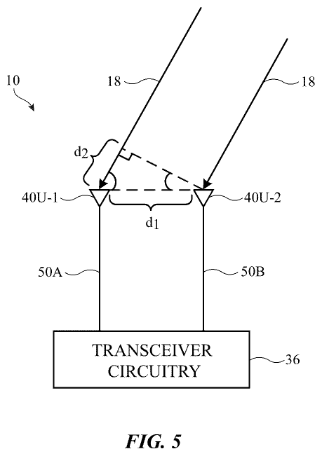

Azimuth angle θ and elevation angle φ may be measured relative to local horizon 64 and reference vector 68. As shown in FIG. 5, the elevation angle φ (sometimes referred to as altitude) of node 60 is the angle between node 60 and local horizon 64 of device 10 (e.g., the angle between vector 67 extending between device 10 and node 60 and a coplanar vector 66 extending between device 10 and local horizon 64). The azimuth angle θ of node 60 is the angle of node 60 around local horizon 64 (e.g., the angle between reference vector 68 and vector 66). In the example of FIG. 4, the azimuth angle θ and elevation angle φ of node 60 are greater than 0°. If desired, other axes besides longitudinal axis 62 may be used to define reference vector 68. For example, the control circuitry may use a horizontal axis that is perpendicular to longitudinal axis 62 as reference vector 68.

After determining the orientation of device 10 relative to node 60, the control circuitry on device 10 may take suitable action. For example, the control circuitry may send information to node 60, may request and/or receive information from 60, may use a display to display a visual indication of wireless pairing with node 60, may use speakers to generate an audio indication of wireless pairing with node 60, may use a vibrator, a haptic actuator, or other mechanical element to generate haptic output indicating wireless pairing with node 60, may use a display to display a visual indication of the location of node 60 relative to device 10, may use speakers to generate an audio indication of the location of node 60, may use a vibrator, a haptic actuator, or other mechanical element to generate haptic output indicating the location of node 60, and/or may take other suitable action.

In some implementations, device 10 may determine the distance D between the device 10 and node 60 and the orientation of device 10 relative to node 60 using two or more UWB antennas. The UWB band antennas may receive UWB signals 18 (FIG. 1) from node 60. UWB signals 18 may carry ranging frames RFRAME. Transmission time stamps in ranging frames RFRAME and corresponding reception time stamps may be analyzed to determine the time of flight of the wireless communication signals and thereby determine the distance D between device 10 and node 60. Additionally, one or more AoA measurement techniques may be used to determine the orientation of electronic device 10 relative to node 60 (e.g., azimuth angle θ and elevation angle q).

In AoA measurement, node 60 may transmit a UWB signal 18 (FIG. 1) to device 10. Device 10 may measure a delay in arrival time of the UWB signal between the two or more UWB antennas. The delay in arrival time (e.g., the difference in received phase at each ultra-wideband antenna) can be used to determine the AoA of the UWB signal (and therefore the angle of node 60 relative to device 10). Once distance D and the AoA have been determined, device 10 may have knowledge of the precise location of node 60 relative to device 10.

FIG. 5 is a schematic diagram showing one example of how AoA measurement techniques may be used to determine the orientation of device 10 relative to node 60 (or vice versa). Device 10 may include multiple antennas 40 for conveying UWB signals 18 (sometimes referred to herein as UWB antennas 40U). As shown in FIG. 5, the UWB antennas 40U in device 10 may include at least a first UWB antenna 40U-1 and a second UWB antenna 40U-2. UWB antennas 40U-1 and 40U-2 may be coupled to transceiver circuitry 36 over respective radio-frequency transmission line paths 50 (e.g., a first radio-frequency transmission line path 50A and a second radio-frequency transmission line path 50B). Transceiver circuitry 36 and UWB antennas 40U-1 and 40U-2 may operate at UWB frequencies (e.g., transceiver circuitry 36 may convey UWB signals 18 using UWB antennas 40U-1 and 40U-2).

UWB antennas 40U-1 and 40U-2 may each receive UWB signals 18 from node 60 (FIG. 5). UWB antennas 40U-1 and 40U-2 may be laterally separated by a distance d₁ on device 10, where UWB antenna 40U-1 is farther away from node 60 than UWB antenna 40U-2 (in the example of FIG. 5). Therefore, UWB signals 18 travel a greater distance to reach UWB antenna 40U-1 than UWB antenna 40U-2. The additional distance between node 60 and UWB antenna 40U-1 is shown in FIG. 5 as distance d₂. FIG. 5 also shows angles a and b (where a+b=) 90°.

Distance d₂ may be determined as a function of angle a or angle b (e.g., d₂=d₁*sin(a) or d₂=d₁*cos(b)). Distance d₂ may also be determined as a function of the phase difference between the signal received by UWB antenna 40U-1 and the signal received by UWB antenna 40U-2 (e.g., d₂=(PD)*λ/(2*π)), where PD is the phase difference (sometimes written “Δϕ”) between the signal received by UWB antenna 40U-1 and the signal received by UWB antenna 40U-2, and λ is the wavelength of UWB signals 18. The two equations for d₂ may be set equal to each other (e.g., d₁*sin(a)=(PD)*λ/(2*π)) and rearranged to solve for the angle a (e.g., a=sin⁻¹((PD)*λ/(2*π*d₁)) or the angle b. Therefore, the angle of arrival may be determined (e.g., by control circuitry 38 of FIG. 2) based on the known (predetermined) distance d₁ between UWB antennas 40U-1 and 40U-2, the detected (measured) phase difference PD between the signal received by UWB antenna 40U-1 and the signal received by UWB antenna 40U-2, and the known wavelength (frequency) of the received radio-frequency signals 56. Angles a and/or b of FIG. 5 may be converted to spherical coordinates to obtain azimuth angle θ and elevation angle φ of FIG. 4, for example. Control circuitry 38 (FIG. 2) may determine the angle of arrival of UWB signals 18 by calculating one or both of azimuth angle θ and elevation angle q.

Distance d₁ may be selected to ease the calculation for phase difference PD between the signal received by UWB antenna 40U-1 and the signal received by UWB antenna 40U-2. For example, d₁ may be less than or equal to one half of the wavelength (e.g., effective wavelength) of the received UWB signals 18 (e.g., to avoid multiple phase difference solutions).

With two antennas for determining angle of arrival (as in FIG. 5), the AoA within a single plane may be determined. For example, UWB antennas 40U-1 and 40U-2 in FIG. 5 may be used to determine azimuth angle θ of FIG. 4. A third UWB antenna may be included to allow AoA determination in multiple planes (e.g., azimuth angle θ and elevation angle φ of FIG. 4 may both be determined). The three UWB antennas in this scenario may form a so-called triplet of UWB antennas, where each antenna in the triplet is arranged to approximately lie on a respective corner of a right triangle (e.g., the triplet may include UWB antennas 40U-1 and 40U-2 of FIG. 5 and a third antenna located at distance d₁ from UWB antenna 40U-1 in a direction perpendicular to the vector between UWB antennas 40U-1 and 40U-2) or using some other predetermined relative positioning. Triplets of UWB antennas 40U may be used to determine angle of arrival in two planes (e.g., to determine both azimuth angle θ and elevation angle φ of FIG. 4). Triplets of UWB antennas 40U and/or doublets of UWB antennas 40U (e.g., a pair of antennas such as UWB antennas 40U-1 and 40U-2 of FIG. 5) may be used in device 10 to determine AoA. If desired, different doublets of antennas may be oriented orthogonally with respect to each other in device 10 to recover AoA in two dimensions (e.g., using two or more orthogonal doublets of UWB antennas 40U that each measure angle of arrival in a single respective plane). If desired, device 10 may include only a single UWB antenna (e.g., for detecting the distance D to an external device using UWB signals 18).

For the sake of illustration, examples are described herein in which device 10A (FIG. 1) transmits UWB signals 18 containing one or more ranging frames RFRAME and in which device 10B (FIG. 1) receives the UWB signals 18 containing the one or more ranging frames RFRAME transmitted by device 10A. Device 10A is therefore sometimes referred to herein as transmitting (TX) device 10A, transmitter device 10A, or transmitter 10A, whereas device 10B is sometimes referred to herein as receiving (RX) device 10B, receiver device 10B, or receiver 10B. This is illustrative and non-limiting. Device 10B may also transmit UWB signals 18 containing one or more ranging frames RFRAME for receipt by device 10A and/or device 10A may also receive UWB signals 18 containing one or more ranging frames RFRAME transmitted by device 10B (e.g., a given device 10 may be a TX device at a first time and may be an RX device at a second time during wireless ranging and localization operations).

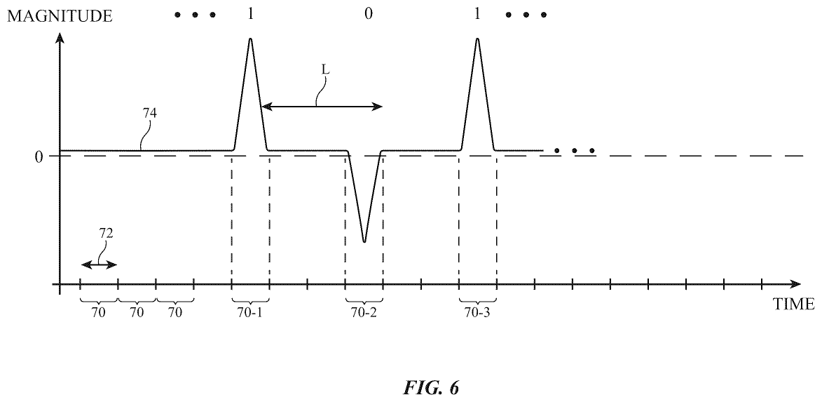

FIG. 6 is a timing diagram illustrating how the UWB signals 18 (FIG. 1) transmitted by TX device 10A may include a set or series of signal pulses over time. As shown in FIG. 6, time is divided into a series of time units 70 of equal duration 72. Time units 70 are also referred to as chips 70. Chips 70 and duration 72 may be defined by the corresponding UWB protocol. The duration 72 of each chip 70 may be equal to the duration of a single pulse in UWB signals 18 (e.g., the pulse width or the width in time of a single pulse in UWB signals 18). Put differently, each chip 70 may represent the time segment of a single pulse in UWB signals 18. Duration 72 may, for example, be 8 ns, 16 ns, more than 16 ns, more than 8 ns, and as low as 2 ns (e.g., representing the closest possible pulse spacing in time between two consecutive pulses in UWB signals 18).

Curve 74 of FIG. 6 illustrates the magnitude of the UWB signal 18 transmitted by TX device 10A over time. UWB signal 18 may include a series of signal pulses. The signal pulses may include positive signal pulses with magnitudes greater and negative signal pulses with magnitudes less than zero. TX device 10A may directly time-modulate wireless data (information) onto UWB signal 18 by modulating the sign (polarity) of the pulses in UWB signal 18 over time. For example, TX device 10A may pulse UWB signal 18 high (e.g., may include a positive pulse with a magnitude greater than zero in the transmitted UWB signal) during a corresponding chip 70 to represent a first binary value of the wireless data modulated onto UWB signal 18 (e.g., binary 1). On the other hand, TX device 10A may pulse UWB signal 18 low (e.g., may include a negative pulse with a magnitude less than zero in the transmitted UWB signal) during a corresponding chip 70 to represent a second binary value of the wireless data modulated onto UWB signal 18 (e.g., binary 0).

In the example of FIG. 6, for instance, TX device 10A may transmit a positive pulse of UWB signal 18 during chip 70-1. This may represent a binary value of 1 in the wireless data conveyed using UWB signal 18. The next pulse in UWB signal 18 may be a negative pulse during a subsequent chip 70-2. This may represent a binary value of 0 in the wireless data conveyed using UWB signal 18. The next pulse in UWB signal 18 may be a positive pulse during a subsequent chip 70-3. This may represent a binary value of 1 in the wireless data conveyed using UWB signal 18. In this way, TX device 10A may use UWB signal 18 to transmit a sequence of pulses from chip 70-1 to chip 70-3 representing the series of binary values “101” in the wireless data conveyed using UWB signal 18.

The time period between consecutive pulses in UWB signal 18 may be characterized by a corresponding spreading factor L. Spreading factor L may, for example, be an integer that represents the number of chips 70 between the end of one pulse and the end of the next pulse in UWB signal 18. In the example of FIG. 6, UWB signal 18 has a spreading factor of L=3. This is illustrative and, in general, UWB signal 18 may have any desired spreading factor. TX device 10A may select a particular spreading factor L to use during the transmission of UWB signal 18. Spreading factor L may be equal to one when TX device 10A transmits pulses during consecutive chips 70. Chips 70 that do not include a corresponding positive or negative pulse of UWB signal 18 are sometimes referred to herein as null chips (e.g., chips at which UWB signals 18 nominally have zero magnitude).

The series of bits of wireless data conveyed using UWB signal 18 (e.g., as represented by positive and negative pulses over time) may collectively represent or convey a corresponding ranging frame RFRAME (FIG. 1). Each ranging frame RFRAME may include thousands of bits of data or more. UWB signal 18 may therefore include a series of thousands of pulses in corresponding chips 70 to convey a single ranging frame RFRAME. The frame structure of ranging frame RFRAME may be specified by the UWB communications protocol.

In some implementations, to help increase the security of UWB signal 18, ranging frame RFRAME may include a scrambled timestamp sequence (STS). The STS may be generated by a cryptographic algorithm such as an Advanced Encryption Standard (AES) random bit generator (e.g., an AES-128 based deterministic random bit generator (DRBG)). The STS may, for example, serve as a unique identifier of the transmitting device (e.g., TX device 10A) that allows the receiving device (e.g., RX device 10B) to distinguish the RFRAME transmitted by the transmitting device from RFRAMEs transmitted by other devices (e.g., attacker devices, man-in-the-middle (MITM) devices, unauthorized devices, unexpected devices, etc.).

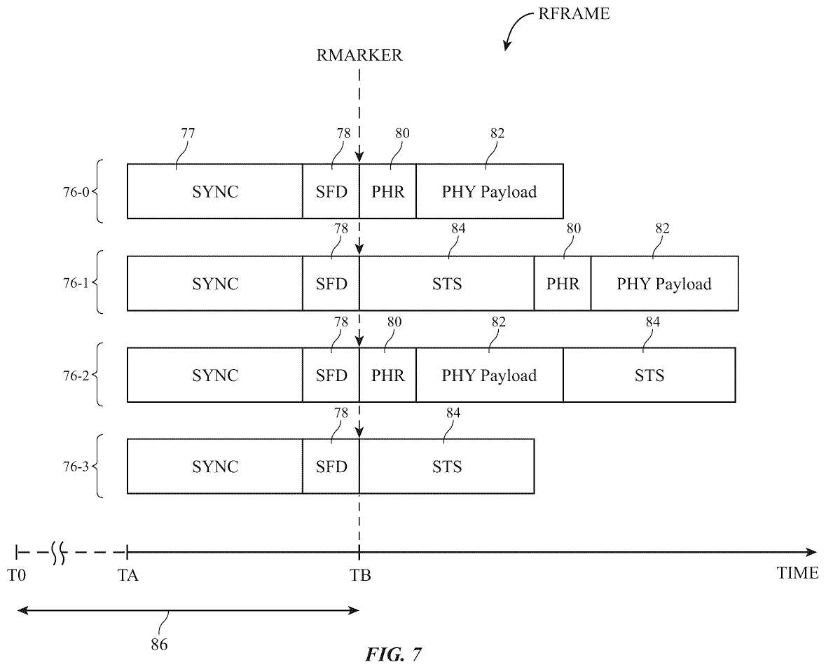

The UWB protocol may specify a set of different frame structures for ranging frame RFRAME, with some or each of the frame structures having a different STS configuration. FIG. 7 is a timing diagram showing four illustrative frame structures for ranging frame RFRAME (e.g., as defined by the UWB protocol). As shown in FIG. 7, TX device 10A may transmit ranging frame RFRAME using a corresponding STS packet configuration 76 (e.g., using STS packet configurations 76-0, 76-1, 76-2, or 76-3).

In STS packet configuration 76-0 (sometimes also referred to herein as STS packet configuration zero), ranging frame RFRAME includes a synchronization (SYNC) field 77, followed by a start of frame delimiter (SFD) 78, followed by a physical layer (PHY) header (PHR) 80, followed by a PHY payload 82 (sometimes also referred to herein as PHY payload field 82 or more simply as payload field 82 or payload 82). In STS packet configuration 76-0, ranging frame RFRAME does not include an STS.

In STS packet configuration 76-1 (sometimes also referred to herein as STS packet configuration one), ranging frame RFRAME includes SYNC field 77, followed by SFD 78, followed by an STS such as STS 84 (e.g., in a corresponding STS field of ranging frame RFRAME), followed by PHR 80, followed by PHY payload 82. In STS packet configuration 76-1, ranging frame RFRAME is similar to STS packet configuration 76-0 but with STS 84 included between SFD 78 and PHR 80 (e.g., for use by the RX device in verifying that ranging frame RFRAME was transmitted by the expected TX device).

In STS packet configuration 76-2 (sometimes also referred to herein as STS packet configuration two), ranging frame RFRAME includes SYNC field 77, followed by SFD 78, followed by PHR 80, followed by PHY payload 82, followed by STS 84. In STS packet configuration 76-2, ranging frame RFRAME is similar to STS packet configuration 76-0 but with STS 84 included after PHY payload 82.

In STS packet configuration 76-3 (sometimes also referred to herein as STS packet configuration three), ranging frame RFRAME includes SYNC field 77, followed by SFD 78, followed by STS 84. In STS packet configuration 76-3, ranging frame RFRAME does not include a PHY payload or a PHY header but does include STS 84 (e.g., for use by the RX device in verifying that ranging frame RFRAME was transmitted by the expected TX device). TX device 10A and RX device 10B may use the MAC layer to configure which of the STS packet configurations are used for ranging frame RFRAME (e.g., both devices may have advanced knowledge of the packet configuration to be used). The examples of FIG. 7 are illustrative and non-limiting. Ranging frame RFRAME may, for example, include additional fields in any STS packet configuration (e.g., additional header fields such as media access control (MAC) header fields, trailer fields such as a cyclic redundancy check (CRC) field after PHY payload 82 and STS 84, other CRC fields, data integrity check fields, etc.).

Devices 10A and 10B may use one or more ranging frames RFRAME (e.g., in any of STS packet configurations 76-0 through 76-3) to perform wireless ranging and localization operations based on time-stamping. For example, devices 10A and 10B may support single-sided two-way ranging (SS-TWR), double-sided two-way ranging (DS-TWR), and/or one-way ranging/time difference of arrival (OWR/TDOA) ranging using ranging frame(s) RFRAME. In SS-TWR, device 10A transmits a first ranging frame RFRAME to device 10B, which then transmits a second ranging frame RFRAME to device 10A for use in detecting range D at one or both devices (e.g., in a single ping-pong configuration of ranging frames RFRAME). In DS-TWR, device 10A transmits a first ranging frame RFRAME to device 10B, which then transmits a second ranging frame RFRAME to device 10A, which then transmits a third ranging frame RFRAME to device 10B for use in detecting range D at one or both devices (e.g., in a ping-pong-ping configuration of ranging frames RFRAME). In OWR/TDOA, device 10A transmits a ranging frame RFRAME to device 10B and device 10B does not transmit a ranging frame to device 10A (e.g., device 10B may listen for ranging frames RFRAME from multiple TX devices to identify its own spatial location/position). Note that, in SS-TWR and DS-TWR, device 10A forms a TX device or a RX device at different times and device 10B forms a RX device or a TX device at different times.

TX device 10A may transmit a given ranging frame RFRAME at an antenna 40 on TX device 10A (sometimes referred to herein as a transmit antenna) at a corresponding transmit time. The transmit time may be characterized by a transmit (TX) time stamp. RX device 10B may receive the ranging frame at an antenna 40 on RX device 10B (sometimes referred to herein as a receive antenna) at a corresponding receive time. The receive time may be characterized by a receive (RX) time stamp. The TX time stamp and the RX time stamp are measured relative to a ranging marker RMARKER in ranging frame RFRAME. Ranging marker RMARKER may be defined (e.g., by the UWB protocol) as the time when the beginning of the first symbol following SFD 78 in ranging frame RFRAME is transmitted or received at the local antenna. For UWB PHYs, this may correspond to the location, in time, of the peak of the first pulse or chip 70 in UWB signals 18 following the end of SFD 78. For example, TX time stamp may be defined as the time at which the transmit antenna on TX device 10A transmits the first pulse in UWB signals 18 following SFD 78 in ranging frame RFRAME. Similarly, the RX time stamp may be defined as the time at which the receive antenna on RX device 10B receives the first pulse in UWB signals 18 following SFD 78 in ranging frame RFRAME. Other definitions for ranging marker RMARKER may be used if desired.

As shown in FIG. 7, for example, TX device 10A may transmit ranging frame RFRAME to RX device 10B using a transmit antenna. TX device 10A may transmit ranging frame RFRAME at a time such that ranging marker RMARKER (e.g., the first pulse or chip following SFD 78) is at the plane of the transmit antenna on TX device 10A at time TO. As such, time TO may represent the TX time stamp for ranging frame RFRAME. TX device 10A may inform RX device 10B of the TX time stamp by including the TX time stamp in the PHY payload 82 of the transmitted ranging frame RFRAME or in the PHY payload of a subsequent ranging frame RFRAME transmitted to RX device 10B.

RX device 10B may begin receiving ranging frame RFRAME at time TA after time TO using a receive antenna. Time TA is sometimes also referred to herein as the time of arrival (ToA) of ranging frame RFRAME. RX device 10B may record, as the RX timestamp of ranging frame RFRAME, the time TB at which ranging marker RMARKER (e.g., the first pulse or chip following SFD 78) is at the plane of the receive antenna. RX device 10B may identify the time-of-flight (TOF) of ranging frame RFRAME between TX device 10A and RX device 10B based on the difference between the recorded RX time stamp and the TX time stamp included in ranging frame RFRAME or included in a subsequent ranging frame RFRAME.

For example, RX device 10B may identify the TOF of ranging frame RFRAME based on the difference 86 between time TB (the RX time stamp) and time TO (the TX time stamp). RX device 10B may then identify (e.g., estimate, generate, compute, calculate, output, etc.) the distance D (FIG. 1) between TX device 10A and RX device 10B based on the identified time-of-flight and the known propagation speed of UWB signals 18. RX device 10B may use one or more measurements of distance D performed using two or more receive antennas on RX device 10B to identify the AoA 20 (FIG. 1) of UWB signals 18. RX device 10B may combine distance D and AoA 20 to identify the precise location/position of TX device 10A relative to RX device 10B. If desired, device 10A may perform similar operations on one or more ranging frames RFRAME transmitted by device 10B to identify the precise location/position of device 10B.

The wireless circuitry on RX device 10B may receive signals while listening for ranging frames RFRAME. The received signals include a superposition of many different signals at different magnitudes produced by all signal sources in the environment. The wireless circuitry on RX device 10B may perform a correlation operation on the received signals to identify receipt of a ranging frame RFRAME transmitted by TX device 10A (as opposed to other signals from other signal sources). The correlation operation may, for example, produce a relatively high correlation value (score) when the received signal matches an expected received signal (e.g., when ranging frame RFRAME has been received) but produces a relatively low correlation value when the received signal does not match the expected received signal (e.g., when signals other than the expected ranging frame RFRAME are received). In practice, the greater the number of bits in the received signal that matches the expected received signal, the higher the correlation value. The correlation value may be represented by a channel impulse response (CIR) value, for example. After successful correlation, RX device 10B may then identify the ToA of the received ranging frame RFRAME, which is then used to derive the time of ranging marker RMARKER in the received ranging frame (e.g., an RX time stamp at time TB). The RX device may then use the RX time stamp and the corresponding TX time stamp to identify TOF and distance D.

In some implementations, RX device 10B performs a correlation operation on the STS 84 in ranging frame RFRAME to identify successful receipt of the ranging frame (e.g., by correlating the STS 84 in the received ranging frame with the STS of TX device 10A, which is known to RX device 10B). However, these implementations require TX device 10A to only utilize an STS packet configuration that includes STS 84 in ranging frame RFRAME (e.g., STS packet configurations 76-1, 76-2, or 76-3 but not STS packet configuration 76-0). This can result in inefficient channel utilization for both devices (e.g., because transmission of STS 84 consumes a substantial amount of the overall time and power involved in conveying ranging frame RFRAME). It would therefore be desirable to be able to perform wireless ranging and localization based on a correlation of a portion of ranging frame RFRAME other than STS 84.

In other implementations, RX device 10B may use correlations of SYNC field 77 and/or SFD 78 to perform wireless ranging and localization. SYNC field 77 may, for example, include a repetition of one ternary preamble code that exhibits an ideal periodic auto-correlation. SFD 78 may, for example, modulate the same ternary code as SYNC field 77. However, SYNC field 77 can be vulnerable to distance-decreasing attacks. For example, an unauthorized adversary device could simply transmit the known preamble code at an advanced timing (or any timing) to confuse RX device 10B about the correct arrival time of ranging frame RFRAME.

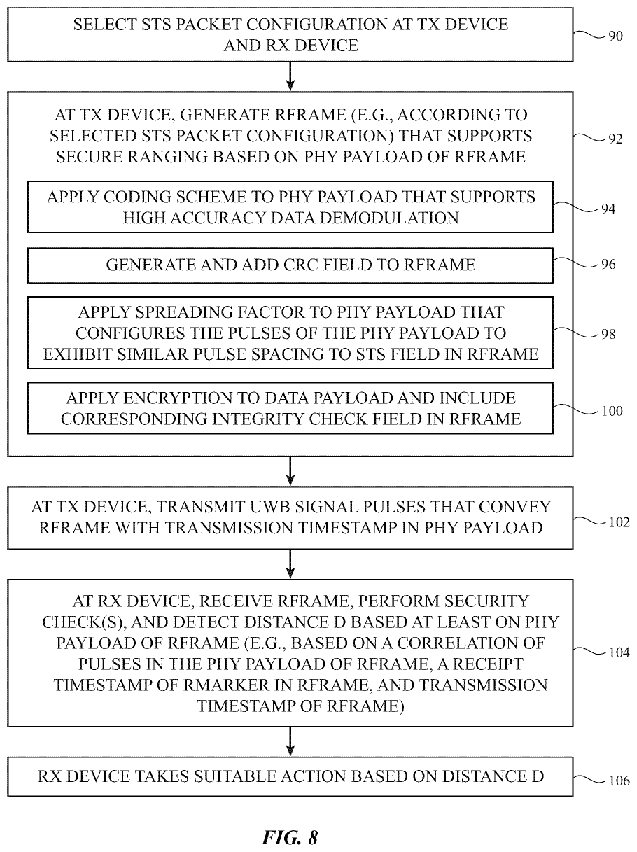

To reduce, or minimize, resource consumption and increase, or maximize, channel efficiency while maintaining a desired level of security against unauthorized adversary devices, RX device 10B may utilize correlations of PHY payload 82 to perform wireless ranging and localization instead of correlations of STS 84, SYNC field 77, or SFD 78. FIG. 8 is a flow chart of operations involved in performing wireless ranging and localization using TX device 10A and RX device 10B.

At operation 90, TX device 10A and RX device 10B may use the MAC layer to select a particular STS packet configuration for use in performing wireless ranging and localization. The selected STS packet configuration may be, for example, an STS packet configuration that includes PHY payload 82, such as STS packet configurations 76-0, 76-1, or 76-2 of FIG. 7.

At operation 92, TX device 10A may generate a ranging frame RFRAME according to the selected STS packet configuration. TX device 10A may generate ranging frame RFRAME in a manner that supports detection of distance D by RX device 10B based on a correlation of the PHY payload 82 in ranging frame RFRAME. In practice, PHY payload 82 can be challenging for RX device 10B to correlate because the data included in PHY payload 82 is often unknown to RX device 10B in advance. To mitigate these issues, TX device 10A may perform one, two, or all of operations 94-98 in generating ranging frame RFRAME.

At operation 94, TX device 10A may apply a selected coding scheme to the PHY payload 82 in ranging frame RFRAME that supports high accuracy data demodulation of PHY payload 82 at RX device 10B. The selected coding scheme may be, for example, a low-density parity-check (LDPC) coding scheme or another coding scheme that allows for demodulation of PHY payload 82 at RX device 10B with a bit error rate (BER) less than a threshold BER (e.g., a BER of 10⁻⁵ or lower). The coding scheme may, for example, involve replications of accurate TX data patterns in the PHY payload in a manner that facilitates correlation by the RX device. This type of high accuracy modulation/demodulation can help to ensure that RX device 10B can use data demodulation to regenerate a highly accurate TX reference if the PHY service data unit (PSDU) is further authenticated. In this example, the coding scheme may allow the regenerated TX reference to operate similar to STS 84 during correlation, allowing for valid channel information estimation that can then be used to estimate ToA and to compute the RX time stamp of ranging marker RMARKER.

At operation 96, TX device 10A may utilize CRC coding in generating ranging frame RFRAME. This may involve computing a CRC for some or all of ranging frame RFRAME and appending the computed CRC to the end of ranging frame RFRAME. After receiving ranging frame RFRAME, RX device 10B may compute its own CRC for the received ranging frame RFRAME and may compare the computed CRC to the CRC included at the end of the received ranging frame. If the CRCs match, this is indicative of RX device 10B correctly receiving ranging frame RFRAME. If the CRCs do not match, the RX device may invalidate the received ranging frame and may discard the invalidated frame from further processing to determine distance D.

At operation 98, TX device 10A may generate the PHY payload 82 of ranging frame RFRAME according to a data format that has a spreading factor L>1 (FIG. 6). The spreading factor greater than one configures consecutive pulses in the UWB signal 18 carrying ranging frame RFRAME to be transmitted in non-consecutive chips 70 (e.g., in chips that are separated by the spreading factor). TX device 10A may utilize a spreading factor L>1 that is the same as or similar to the spreading factor used for STS 84. This may configure the pulse positions (time spacings) that represent PHY payload 82 in UWB signal 18 to match the pulse positions that represent STS 84 in UWB signal 18. This may help to facilitate demodulation and correlation of PHY payload 82 at RX device 10B. As two examples, TX device 10A may generate PHY payload 82 with a spreading factor of L=4 or L=8. Other non-zero spreading factors may be used if desired.

If desired, TX device 10A may perform operation 100 to help increase security (e.g., to help RX device 10B to guarantee that its received ranging frame RFRAME was actually transmitted by TX device 10A instead of a different/unauthorized device). At operation 100, TX device 10A may apply an encryption algorithm or function to PHY payload 82 to encrypt the PHY payload. The encryption algorithm or function may also produce a corresponding data integrity check (IC) value. TX device 10A may include the data integrity check value in a field of the transmitted ranging frame RFRAME. As one example, TX device 10A may use a MAC encryption algorithm such as an AES algorithm (e.g., AES-128) to PHY payload 82 to encrypt PHY payload 82 and/or to generate the data integrity check value.

After receiving ranging frame RFRAME, RX device 10B may compute its data integrity check value for the received ranging frame RFRAME (e.g., using the same encryption algorithm or function as used by TX device 10A) and may compare the computed data integrity check value to the data integrity check value included in the received ranging frame. If the data integrity check values match, this is indicative of the received ranging frame RFRAME being transmitted by the authentic TX device 10A. If the data integrity check values do not match, the RX device may invalidate the received ranging frame and may discard the invalidated frame from further processing to determine distance D. If desired, TX device 10A may generate the CRC for ranging frame RFRAME on top of both the data integrity check field and the PHY payload of ranging frame RFRAME.

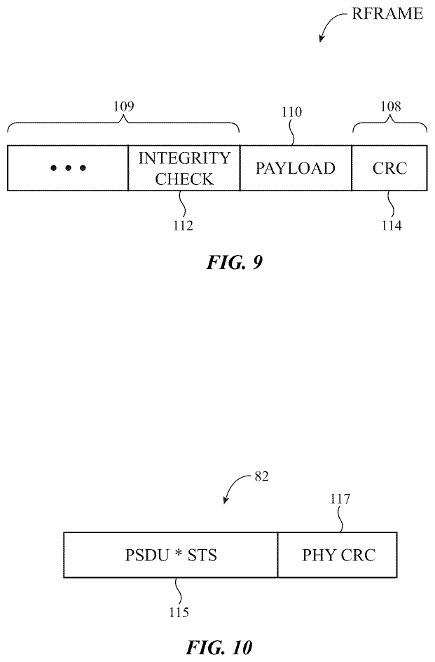

FIGS. 9 and 10 show two examples of how TX device 10A may integrity protect ranging frame RFRAME. As shown in the example of FIG. 9, ranging frame RFRAME may include a header 109 (e.g., a MAC header), a footer 108 (e.g., a MAC footer), and a payload 110 (e.g., a MAC payload) between header 109 and footer 108. Header 109, footer 108, and payload 110 may, for example, form a MAC frame that is included in the PHY payload 82 (FIG. 7) of ranging frame RFRAME. TX device 10A may generate an integrity check value for payload 110 (e.g., by inputting the contents of payload 110 to the encryption algorithm or function at operation 100 of FIG. 8). TX device 10A may include the integrity check value in integrity check field 112 of header 109 (e.g., an auxiliary security header field of a MAC header in header 109). TX device 10A may generate a CRC value 114 for ranging frame RFRAME (e.g., by inputting the contents of payload 110 and/or integrity check field 112 to a CRC generating function or algorithm at operation 96 of FIG. 8). TX device 10A may include CRC value 114 in footer 108.

In the example of FIG. 10, TX device 10A utilizes a PHY level data integrity check for ranging frame RFRAME (e.g., instead of using MAC secure authentication). In this implementation, both TX device 10A and RX device 10B may be connected via a secure cryptographic link that secures the transmitted PHY data payload. For example, the STS generated using an AES-128-based deterministic random bit generator (DRBG) may be used to encrypt and secure authentic data (e.g., in field 115), which is then further protected using a PHY CRC field 117. Integrity check fields may be omitted from ranging frame RFRAME if desired (e.g., operation 100 of FIG. 8 may be omitted).

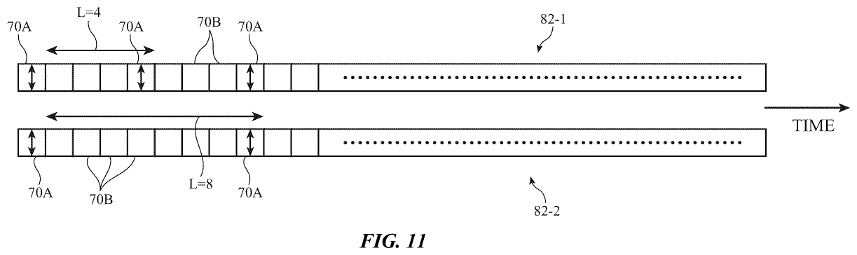

FIG. 11 is a timing diagram showing two illustrative configurations for the PHY payload 82 in ranging frame RFRAME. As shown in FIG. 11, PHY payload 82-1 illustrates an example in which the PHY payload is generated using a spreading factor of L=4 and PHY payload 82-2 illustrates an example in which the PHY payload is generated using a spreading factor of L=8 (e.g., while processing operation 98 of FIG. 8).

As shown by PHY payload 82-1, when a spreading factor of L=4 is used, TX device 10A may transmit PHY payload 82-1 with positive or negative pulses during chips 70A (also referred to herein as non-zero chips 70A). Consecutive non-zero chips 70A are separated by a set of null chips 70B. Because spreading factor L is defined as the number of chips 70 from the end of a first non-zero chip 70A to the end of the next non-zero chip 70A in ranging frame RFRAME, the number of null chips 70B between consecutive non-zero chips 70A (e.g., between consecutive pulses of UWB signal 18) is equal to one less than spreading factor L (e.g., there are L−1=4−1=3 null chips 70B between consecutive non-zero chips 70A in PHY payload 92-1). In this example, PHY payload 82-1 may have a 124.8 MHz Pulse Repetition Frequency (PRF), an LDPC coding rate of 0.5, and a pulse modulation of BPSK, configuring PHY payload 82-1 to exhibit a data rate of 62.4 Mbps. The PRF of 124.8 MHz produced by spreading factor L=4 may, for example, match the PRF of STS 84 when ranging frame RFRAME is transmitted in an HPRF mode.

As shown by PHY payload 82-2, when a spreading factor of L=8 is used, TX device 10A may transmit PHY payload 82-1 with positive or negative pulses during chips 70A that are separated by L−1=8−1=7 null chips 70B. In this example, the spreading factor L=8 may configure PHY payload 82-2 to exhibit a PRF of 62.4 Mbps, which may match the PRF of STS 84 when ranging frame RFRAME is transmitted in a BPRF mode.

When a spreading factor L greater than one is used, there is at least one null chip 70B between each pair of consecutive pulses in the portion of UWB signal 18 representing PHY payload 82 (e.g., rather than utilizing a continuous pulse structure in which repetitions of a given pulse are performed during consecutive chips 70). Put differently, the pulses of UWB signal 18 representing PHY payload 82 are not transmitted during any pair of consecutive chips 70. This type of pulse spacing may configure the pulse spacing representing PHY payload 82 to match the pulse spacing representing STS 84, helping RX device 10B to be able to efficiently and correctly correlate PHY payload 82 for use in detecting distance D (e.g., by allowing the RX device to reuse existing STS processing units for PHY data-based CIR generation).

This is illustrative and non-limiting. Alternatively, operation 98 of FIG. 8 may be omitted and PHY payload 82 may be transmitted using a pulse spacing that does not match the pulse spacing of STS 84 (e.g., TX device 10A may transmit PHY payload 82 using a spreading factor of L=1 or using a spreading factor that is different than the spreading factor of STS 84, may transmit consecutive pulses of PHY payload 82 during consecutive chips 70, may transmit a burst of repetitions of a given pulse of PHY payload 82 during consecutive chips 70, may transmit PHY payload 82 using a continuous pulse structure, etc.). More generally, any desired format may be used for PHY payload 82 (e.g., formats that do not implement a spreading factor greater than one, IEEE formats such as burst+guard interval formats, etc.). In an implementation where an IEEE 802.15.4z format is used for PHY payload 82, PHY payload 82 may include, for example, burst periods separated by one or more guard periods, where a burst period includes a repeated burst of signal pulses (e.g., having the same sign or polarity). RX device 10B may still be able to generate authenticated data to correlate with the received signal for generating channel impulse response (CIR) values. For example, additional CIR value processing and/or filtering may be performed rather than reusing processing units used for STS processing to also process the PHY payload.

Returning to FIG. 8, at operation 102, TX device 10A may transmit the ranging frame RFRAME generated at operation 92 to RX device 10B. TX device 10A may transmit ranging frame RFRAME at a transmit time characterized by a TX time stamp (e.g., measured relative to the ranging marker RMARKER in ranging frame RFRAME). If desired, TX device 10A may include the TX time stamp in the PHY payload 82 of the transmitted ranging frame RFRAME. Alternatively, TX device 10A may transmit the TX time stamp in a subsequently transmitted ranging frame RFRAME.

TX device 10A may transmit ranging frame RFRAME using pulses of UWB signals 18. Each pulse may represent a respective bit of ranging frame RFRAME (e.g., where a positive pulse represents a bit value of binary 1 and a negative pulse represents a bit value of binary 0 or vice versa). TX device 10A may transmit the pulses of the PHY payload 82 in ranging frame RFRAME such that each pulse is separated in time from the previous pulse and/or the next pulse by a number of null chips 70B (FIG. 11), where the number of null chips 70B between consecutive pulses is one less than the spreading factor L>1 of PHY payload 82 (e.g., L=4 as shown by PHY payload 82-1 of FIG. 11 or L=8 as shown by PHY payload 82-2 of FIG. 11).

At operation 104, RX device 10B may receive the transmitted ranging frame RFRAME. RX device 10B may identify (e.g., estimate, detect, generate, output, calculate, compute, etc.) distance D between TX device 10A and RX device 10B (FIG. 1) based at least in part on the PHY payload 82 of the received ranging frame RFRAME (e.g., based on a correlation of the PHY payload 82 in the received ranging frame RFRAME). RX device 10B may perform one or more security checks (e.g., integrity check(s) and/or CRC validation(s)) on the received ranging frame RFRAME to ensure that the ranging frame was correctly received and/or to ensure that the ranging frame was transmitted by the expected (authentic) TX device 10A. RX device 10B may, for example, identify the RX time stamp of the received ranging frame RFRAME (e.g., measured relative to the ranging marker RMARKER in ranging frame RFRAME) based on the correlation of PHY payload 82, may identify the corresponding TX time stamp of the received ranging frame RFRAME (e.g., as included in the PHY payload 82 of ranging frame RFRAME by TX device 10A or as included in the PHY payload 82 of a later ranging frame RFRAME transmitted by TX device 10A and received by RX device 10B), and may estimate distance D based on the TX and RX time stamps.

At operation 106, RX device 10B may take suitable action based on the estimated distance D. For example, RX device 10B may also identify the AoA 20 (FIG. 1) of UWB signals 18 and thus the angular location of TX device 10A relative to RX device 10B. As other examples, RX device 10B may transmit other information to TX device 10A, may request and/or receive information from TX device 10A, may use a display to display a visual indication of wireless pairing with TX device 10A, may use speakers to generate an audio indication of wireless pairing with TX device 10A, may use a vibrator, a haptic actuator, or other mechanical element to generate haptic output indicating wireless pairing with TX device 10A, may use a display to display a visual indication of the location of TX device 10A relative to device 10 (e.g., using a mapping or geolocation application), may use speakers to generate an audio indication of the location of TX device 10A, may use a vibrator, a haptic actuator, or other mechanical element to generate haptic output indicating the location of TX device 10A, and/or may take other suitable action. If desired, RX device 10B may transmit one or more ranging frames RFRAME to TX device 10A (e.g., for use by TX device 10A in detecting distance D and/or the location of RX device 10B).

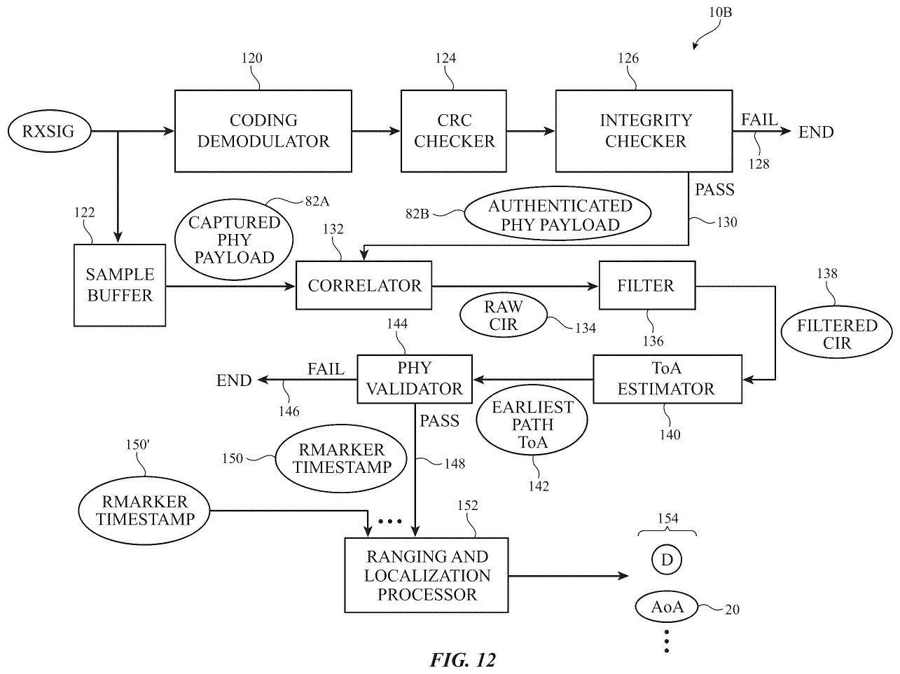

FIG. 12 is schematic circuit block diagram showing how RX device 10B may process a received signal RXSIG while performing wireless ranging and localization. The components of FIG. 12 may be included as a part of wireless circuitry 34 and/or control circuitry 38 of FIG. 2, for example. The components of FIG. 12 may be implemented using hardware (e.g., digital circuitry, digital logic gates, baseband circuitry, analog circuitry, storage circuitry, one or more processors, etc.) and/or software (e.g., as stored on storage circuitry and executed using one or more processors).

As shown in FIG. 12, RX device 10B may include coding demodulator 120, sample buffer 122, CRC checker 124, integrity checker 126, correlator 132, filter 136, ToA estimator 140, PHY validator 144, and ranging and localization processor 152. The input of coding demodulator 120 and the input of sample buffer 122 may be communicatively coupled to an antenna 40 (FIG. 2) on RX device 10B (e.g., via a corresponding receive path or chain in the wireless circuitry of RX device 10B). Coding demodulator 120 is sometimes also referred to herein as demodulation circuitry 120, demodulator 120, data demodulator 120, demodulator block 120, demodulator engine 120, or demodulator circuitry 120. The output of coding demodulator 120 may be coupled to the input of CRC checker 124. The output of sample buffer 122 may be coupled to a first input of correlator 132.

CRC checker 124 is sometimes also referred to herein as CRC checking circuitry 124, CRC checking engine 124, or CRC checking block 124. Integrity checker 126 is sometimes also referred to herein as integrity checking circuitry 126, integrity checking engine 126, or integrity checking block 126. The output of CRC checker 124 may be coupled to the input of integrity checker 126. The output of integrity checker 126 may be coupled to a second input of correlator 132.

Correlator 132 is sometimes also referred to herein as correlation circuitry 132, correlation engine 132, or correlation block 132. The output of correlator 132 may be coupled to the input of filter 136. Filter 136 is sometimes also referred to herein as filter circuitry 136 or filter block 136. The output of filter 136 may be coupled to the input of ToA estimator 140. ToA estimator 140 is sometimes also referred to herein as ToA estimation circuitry 140, ToA estimation block 140, or ToA estimation engine 140. The output of ToA estimator 140 may be coupled to the input of PHY validator 144.

PHY validator 144 is sometimes also referred to herein as PHY validation circuitry 144, PHY validation block 144, or PHY validation engine 144. The output of PHY validator 144 may be coupled to an input of ranging and localization processor 152. Ranging and localization processor 152 is sometimes also referred to herein as ranging and localization processing circuitry 152, ranging and localization circuitry 152, ranging and localization engine 152, or ranging and localization block 152.

During wireless ranging and localization operations, an antenna 40 (FIG. 2) on RX device 10B may receive signal RXSIG (e.g., at operation 104 of FIG. 8). The received signal RXSIG may contain a ranging frame RFRAME transmitted by TX device 10A (e.g., at operation 102 of FIG. 8). The received signal RXSIG may be captured and stored in sample buffer 122 and may also be passed to coding demodulator 120. The stored signal may include a captured PHY payload 82A of ranging frame RFRAME.

Additional demodulation circuitry (not shown) in RX device 10B may demodulate SYNC field 77 and SFD 78 (FIG. 7) in the received signal RXSIG. After SYNC field 77 and SFD 78 have been demodulated, coding demodulator 120 may demodulate the PHY payload 82 of ranging frame RFRAME. Coding demodulator 120 may, for example, demodulate, decode, or reverse the coding scheme applied to PHY payload 82 by TX device 10A at operation 94 of FIG. 8 (e.g., a different coding scheme than used by TX device 10A to transmit SYNC field 77, SFD 78, and optionally the STS of the ranging frame). The demodulated PHY payload 82 output by coding demodulator 120 may exhibit a BER less than the threshold BER supported by the coding scheme, for example.

After demodulation, CRC checker 124 may check one or more CRC fields in ranging frame RFRAME (e.g., CRC field 114 of FIG. 9, PHY CRC field 117 of FIG. 10, etc.). CRC checker 124 may, for example, generate a CRC value for ranging frame RFRAME and may compare the generated CRC value to a CRC value included in a CRC field of ranging frame RFRAME. If CRC checker 124 is unable to validate the CRC field(s) (e.g., the generated CRC value does not match the CRC field), the ranging frame may be discarded from further processing. If CRC checker 124 is able to validate the CRC field(s) (e.g., the generated CRC value matches the CRC field), CRC checker 124 may pass the demodulated PHY payload 82 to integrity checker 126.

Integrity checker 126 may check (validate) one or more data integrity check fields in ranging frame RFRAME (e.g., integrity check field 112 of FIG. 9, field 115 of FIG. 10, etc.). Integrity checker 126 may, for example, generate a data integrity check value for the demodulated PHY payload and may compare the generated data integrity check value to a data integrity check value included in a data integrity check field of ranging frame RFRAME. If/when integrity checker 126 is unable to validate the data integrity check field (e.g., the generated data integrity check value does not match the data integrity check field), the ranging frame may be discarded from further processing (e.g., ranging using the corresponding ranging frame fails and processing proceeds along path 128). If/when integrity checker 126 is able to validate the data integrity check field (e.g., the generated data integrity check value matches the data integrity check field), integrity checker 126 may pass the demodulated PHY payload 82 to correlator 132 as authenticated PHY payload 82B (e.g., the PHY payload 82 of ranging frame RFRAME that is confirmed as having been transmitted by an expected authentic TX device 10A).

Sample buffer 122 may store the captured PHY payload 82A from ranging frame RFRAME while coding demodulator 120, CRC checker 124, and integrity checker 126 operate on the received signal. Correlator 132 may correlate authenticated PHY payload 82B with the captured PHY payload 82A stored on sample buffer 122 to generate a raw (unfiltered) CIR value 134. The correlation performed by correlator 132 may, for example, allow RX device 10B to distinguish the received ranging frame RFRAME in the received signal RXSIG from other signals transmitted by other signal sources. Raw CIR value 134 may, for example, be relatively high when the amount of correlation between authenticated PHY payload 82B and captured PHY payload 82A is relatively strong (e.g., when authenticated PHY payload 82B matches captured PHY payload 82A).

Since the content of PHY payload 82 is unknown to RX device 10B in advance, raw CIR value 134 can be relatively noisy (e.g., may include excessive sidelobe signal components). Filter 136 may filter raw CIR value 134 to produce a corresponding filtered CIR value 138. Filter 136 may, for example, filter out, cancel, or remove sidelobes from raw CIR value 134 (e.g., filtered CIR value 138 may be free from the sidelobes in raw CIR value 134). Filter 136 may pass filtered CIR value 138 to ToA estimator 140. While referred to herein as a filter for the sake of simplicity, filter 136 need not include a digital filter and may, in general, include any desired sidelobe cancellation logic.

ToA estimator 140 may identify (e.g., estimate, output, generate, etc.) an earliest path ToA 142 of the received ranging frame RFRAME based on filtered CIR 138. Earliest path ToA 142 may, for example, characterize the earliest time at which ranging frame RFRAME was received at RX device 10B (e.g., characterizing the reception of ranging frame RFRAME over the LOS path to TX device 10A, which occurs prior to receiving reflected versions of ranging frame RFRAME from the environment). ToA estimator 140 may pass earliest path ToA 142 to PHY validator 144.

PHY validator 144 may identify (e.g., detect, calculate, compute, estimate, generate, etc.) the RX time stamp of ranging frame RFRAME based on earliest path ToA 142 (e.g., as RX time stamp 150 relative to the ranging marker RMARKER in ranging frame RFRAME). PHY validator 144 may also validate PHY ranging security of ranging frame RFRAME (e.g., in addition to a MAC data integrity check performed by integrity checker 126). This may include, for example, guaranteeing that the PHY ranging estimate is larger than the true physical range (e.g., where a ranging receiver is validated as secure when it ensures that a given estimate of earliest path ToA 142, also referred to as n, is accepted with a probability less than a threshold TH whenever it is earlier than time w-A, where to is the true time of the first path timing and A is a positive headroom constant). If/when PHY validator 144 is unable to successfully validate PHY ranging security, ranging frame RFRAME and the RX time stamp may be discarded from further processing (e.g., ranging using the corresponding ranging frame fails and processing proceeds along path 146). If/when PHY validator 144 is able to validate PHY ranging security, PHY validator 144 may pass RX time stamp 150 to ranging and localization processor 152.

Ranging and localization processor 152 may generate ranging and localization information 124 based on RX time stamp 150 and the TX time stamp of the corresponding ranging frame RFRAME (e.g., as included in that ranging frame or in a subsequently received ranging frame RFRAME). Ranging and localization information 154 may include distance D, AoA 20, and/or any other desired information indicative of the position and/or orientation of TX device 10A relative to RX device 10B. If desired, ranging and localization information 154 may combine RX time stamp 150 with one or more additional RX time stamps 150′ (e.g., generated from different ranging frames RFRAME transmitted by the same TX device 10A or one or more additional TX devices) to generate range and localization information 154. Range and localization information 154 may be passed up the protocol stack for further processing (e.g., by processing circuitry 32 of FIG. 2, at operation 106 of FIG. 8, etc.).

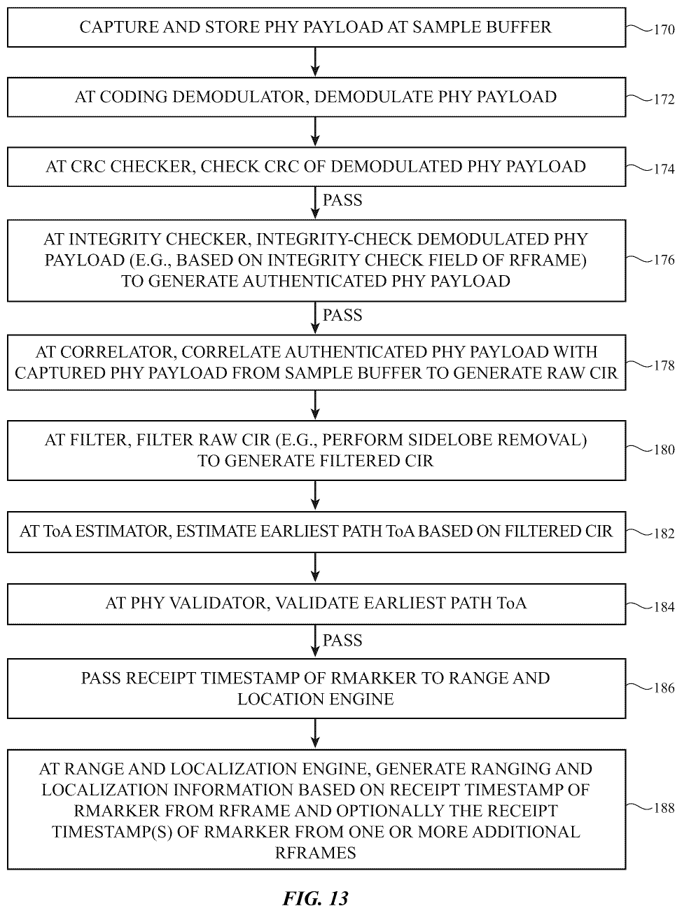

FIG. 13 is a flow chart of operations that may be processed by RX device 10B to perform wireless ranging and localization operations based on ranging frames RFRAME transmitted by TX device 10A. RX device 10B may perform the operations of FIG. 13 while processing operation 104 of FIG. 8, for example.

At operation 170, sample buffer 122 may capture and store at least PHY payload 82 of ranging frame RFRAME in the received signal RXSIG (e.g., as captured PHY payload 82A).

At operation 172, which may be concurrent with operation 170, coding demodulator 120 may demodulate, reverse, or decode the coding of the PHY payload 82 of the ranging frame RFRAME in the received signal RXSIG.

At operation 174, CRC checker 124 may check one or more CRCs of the demodulated PHY payload 82. Processing may proceed to operation 176 if/when the CRC checker is able to validate the CRCs of the demodulated PHY payload 82.

At operation 176, integrity checker 126 may integrity check the demodulated PHY payload 82 (e.g., based on one or more integrity check fields in ranging frame RFRAME). If/when integrity checker 126 is able to successfully validate the integrity of the demodulated PHY payload 82, integrity checker 126 may transmit the demodulated PHY payload to correlator 132 (as authenticated PHY payload 82B) and processing may proceed to operation 178.

At operation 178, correlator 132 may generate raw CIR value 134 by correlating authenticated PHY payload 82B with the captured PHY payload 82A stored on sample buffer 122.

At operation 180, filter 136 may generate filtered CIR value 138 by filtering raw CIR value 134 (e.g., removing sidelobes from raw CIR value 134).

At operation 182, ToA estimator 140 may estimate earliest path ToA 142 based on filtered CIR value 138.

At operation 184, PHY validator 144 may validate the PHY ranging security of ranging frame RFRAME. PHY validator 144 may also estimate, generate, and/or identify the RX time stamp 150 of ranging frame RFRAME based on earliest path ToA 142. If/when PHY validator 144 is able to successfully validate the PHY ranging security of ranging frame RFRAME, processing may proceed to operation 186.

At operation 186, PHY validator 144 may transmit RX time stamp 150 to range and localization processor 152.

At operation 188, range and localization processor 152 may generate range and localization information 154 based on RX time stamp 150, the TX time stamp of ranging frame RFRAME (e.g., as included in the PHY payload of the ranging frame or in the PHY payload of a subsequently received ranging frame), and optionally one or more RX time stamps 150′ of additional ranging frames RFRAME received at RX device 10B.

In this way, devices 10 may perform secure wireless ranging and localization without explicitly requiring transmission of STS 84 in ranging frames RFRAME, resulting in improved channel usage efficiency. In some implementations described herein, high performance coding (e.g., LDPC coding) may be applied to the PHY payload 82 of the transmitted ranging frame RFRAME, followed with CRC coding and a MAC data integrity check to ensure data authentication prior to regenerating the TX reference at RX device 10B for channel information estimation (e.g., generation of raw CIR value 134). These examples described herein are illustrative and non-limiting. If desired, these techniques may be applied to any implementations that utilize data decisions from PHY payload 82 to regenerate a correlation reference at a receiving device for channel information estimation and further ranging. For example, at very high signal-to-noise ratios, the coding demodulator 120 at RX device 10B may apply hard slice demodulation to obtain a data decision, which can be used as the correlation reference. If desired, data integrity checking (e.g., integrity checker 126 of FIG. 12 and operation 176 of FIG. 13) may be omitted for ranging purposes.

In practice, ranging is tightly coupled with related data. For certain applications, ranging information may be stamped along with specific data. If desired, secure ranging may also be achieved without explicit STS transmission via MAC data security (integrity) check. In practice, RX device 10B still produces a ranging result (e.g., ranging and localization information 154 of FIG. 12) even when the RX device receives a ranging frame RFRAME transmitted with STS packet configuration zero (e.g., STS packet configuration 76-0 of FIG. 7). In contrast, RX devices that do not detect range D based on a correlation of PHY payload 82 (e.g., RX devices that detect range D based on a correlation of STS 84) would be unable to output distance D or other ranging and localization information responsive to receive of a ranging frame RFRAME of STS packet configuration zero.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Devices 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-13 may be performed using software, firmware, and/or hardware (e.g., dedicated circuitry or hardware). Software code for performing these operations may be stored on non-transitory computer readable storage media (e.g., tangible computer readable storage media) stored on one or more of the components of devices 10 (e.g., storage circuitry 30 of FIG. 2). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of devices 10 (e.g., processing circuitry 32 of FIG. 2). The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein.

An apparatus may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus including logic, modules, or circuitry to perform one or more elements of a method described in or related to any of the method or process described herein.

An apparatus including: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is illustrative and various modifications can be made by those skilled in the art without departing from the scope and spirit of the described embodiments. The foregoing embodiments may be implemented individually or in any combination.

What is claimed is:

1. A method of operating an electronic device comprising:
receiving, from an external device, an ultra-wideband (UWB) signal that comprises a ranging frame; and
estimating, using one or more processors, a range to the external device based on a correlation of pulses in the UWB signal that represent a physical layer (PHY) payload of the ranging frame and that are associated with non-consecutive chips of the UWB signal, wherein the non-consecutive chips are separated by one or more null chips of the UWB signal.

2. The method of claim 1, wherein the ranging frame includes a scrambled timestamp sequence (STS) conveyed by a series of pulses in the UWB signal having a spreading factor greater than one, and the spreading factor is also used for the pulses in the UWB signal that represent the PHY payload of the ranging frame.

3. The method of claim 2, wherein the spreading factor is equal to four chips or eight chips of the UWB signal.

4. The method of claim 1, wherein the ranging frame does not include a scrambled timestamp sequence.

5. The method of claim 1, further comprising:
generating, using the one or more processors, an integrity check value based on the PHY payload of the ranging frame; and
validating, using the one or more processors, an integrity check field of the ranging frame based on the integrity check value.

6. The method of claim 5, further comprising:
generating, using the one or more processors, a cyclic redundancy check (CRC) value based on the PHY payload and the integrity check field of the ranging frame; and
validating, using the one or more processors, a CRC field of the ranging frame based on the CRC value.

7. The method of claim 1, further comprising:
generating, using the one or more processors, a channel impulse response (CIR) value based on the correlation of pulses in the UWB signal that represent the PHY payload of the ranging frame, wherein estimating the range comprises estimating the range based on the CIR value.

8. The method of claim 7, further comprising:
generating, using the one or more processors, a filtered CIR value by filtering out a sidelobe from the CIR value, wherein estimating the range comprises estimating the range based on the filtered CIR value.

9. The method of claim 7, further comprising:
storing the PHY payload of the ranging frame in a sample buffer;
reversing, using the one or more processors, a coding scheme applied to the PHY payload by the external device to generate a demodulated PHY payload; and
generating the CIR value by correlating the demodulated PHY payload with the PHY payload stored in the sample buffer.

10. The method of claim 9, further comprising:
generating, using the one or more processors, an integrity check value of the demodulated PHY payload prior to generating the CIR value; and
comparing, using the one or more processors, the integrity check value to an integrity check field in the ranging frame.

11. The method of claim 9, wherein the coding scheme comprises a low-density parity-check coding scheme.

12. A method of operating an electronic device comprising:
generating, using one or more processors, a ranging frame that includes a physical layer (PHY) payload; and
transmitting, using one or more antennas, an ultra-wideband (UWB) signal that includes pulses representing the ranging frame, wherein
the pulses include a series of pulses representing the PHY payload,
the series of pulses has a spreading factor greater than one,
the series of pulses are transmitted in non-zero chips of the UWB signal, and
consecutive pulses in the series of pulses are separated by at least one null chip of the UWB signal.

13. The method of claim 12, wherein generating the ranging frame comprises:
applying a low-density parity-check coding scheme to the PHY payload.

14. The method of claim 12, wherein generating the ranging frame comprises:
encrypting the PHY payload using an Advanced Encryption Standard (AES) algorithm that generates an integrity check value.

15. The method of claim 14, further comprising:
representing the integrity check value in an integrity check field of the ranging frame.

16. The method of claim 15, wherein generating the ranging frame further comprises:
generating a cyclic redundancy check (CRC) value based on the integrity check field and the PHY payload; and
including the CRC value in a footer of the ranging frame.

17. The method of claim 12, wherein the ranging frame does not include a scrambled timestamp sequence.

18. The method of claim 12, wherein the non-zero spreading factor is equal to four chips or eight chips of the UWB signal.

19. An electronic device comprising:
one or more antennas configured to receive an ultra-wideband (UWB) signal from an external device, the UWB signal comprising a ranging frame;
one or more processors configured to
generate a channel impulse response (CIR) value based on a correlation of pulses in the UWB signal, the pulses representing a physical layer (PHY) payload of the ranging frame, and
estimate a location of the external device based on the CIR value; and
a display configured to display an image indicative of the estimated location.

20. The electronic device of claim 19, the one or more processors being further configured to demodulate, prior to generating the CIR value, a coding scheme applied to the PHY payload of the ranging frame by the external device.
